(19) United States
(12) Patent Application Publication
(10) Pub. No.: US 2024/0055179 A1
(43) Pub. Date: Feb. 15, 2024

(54) POWER TRANSFORMER HAVING A NOISE REDUCTION FUNCTION

(71) Applicant: Fortune Electric Co., Ltd., Taoyuan City (TW)

(72) Inventors: CHIA-CHING LIN, Taoyuan City (TW); CHING-MIN CHEN, Taoyuan City (TW)

(21) Appl. No.: 18/105,343

(22) Filed: Feb. 3, 2023

(30) Foreign Application Priority Data
Aug. 12, 2022 (TW) 111208755

(51) Int. Cl. H01F 27/33; H01F 27/02; H01F 27/24; H01F 27/28

(52) U.S. Cl. CPC H01F 27/33; H01F 27/02; H01F 27/24; H01F 27/28

(57) ABSTRACT

A power transformer having a noise reduction function includes a transformer housing and an electromagnetic assembly. The transformer housing includes a sidewall and an accommodating space surrounded by the sidewall, and the sidewall has a vacuum layer formed therein. The electromagnetic assembly is disposed in the accommodating space and includes an iron core and a coil structure disposed on the iron core. The transformer housing can include at least one hollow reinforcing structure disposed on an outer wall of the sidewall and filled with an anti-vibration material.

### CROSS-REFERENCE TO RELATED PATENT APPLICATION

This application claims the benefit of priority to Taiwan Patent Application No. 111208755, filed on Aug. 12, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a transformer for power transmission and distribution systems, and more particularly to a power transformer having a noise reduction function.

### BACKGROUND OF THE DISCLOSURE

Transformers are very important power equipment in any power transmission and distribution system. During the operation of a transformer, components such as a housing, an iron core and windings thereof, and a fan generate noise, and part of such noise can be amplified due to a resonance effect, which can seriously disturb people in the vicinity (e.g., a technical staff or a maintenance staff). Therefore, the present disclosure provides a novel power transformer that is effective in reducing noise. In recent years, with the growth of environmental awareness, the management of transformer noises is gaining increasing attention. Therefore, much research has been dedicated to providing better noise management technology.

Studies have shown that people who are exposed to noise over a long period of time will have the following symptoms: hearing impairment, reduced learning and work efficiencies, reduced sleep quality, and negative effects on the nervous system, cardiovascular system, and endocrine system. Most of the noise generated by a transformer is low-frequency noise that is penetrative and decays very slowly, which makes the noise easily heard by humans. Moreover, people normally have a low degree of tolerance for low-frequency noise. Therefore, how to improve the structural design to reduce the noise of the transformer, so as to overcome the above-mentioned inadequacies, has become one of the important issues to be addressed in the industry.

### SUMMARY OF THE DISCLOSURE

In response to the above-referenced technical inadequacies, the present disclosure provides a power transformer having a noise reduction function.

In one aspect, the present disclosure provides a power transformer having a noise reduction function, which includes a transformer housing and an electromagnetic assembly. The transformer housing includes a sidewall and an accommodating space surrounded by the sidewall, and the sidewall has a vacuum layer formed therein. The electromagnetic assembly is disposed in the accommodating space and includes an iron core and a coil structure disposed on the iron core.

In one embodiment of the present disclosure, a thickness of the vacuum layer is from 90% to 92.5% of a total thickness of the sidewall.

In one embodiment of the present disclosure, the transformer housing further includes at least one hollow reinforcing structure disposed on an outer wall of the sidewall, and the at least one hollow reinforcing structure is filled with an anti-vibration material.

In one embodiment of the present disclosure, the at least one hollow reinforcing structure surrounds the sidewall of the transformer housing.

In one embodiment of the present disclosure, the at least one hollow reinforcing structure includes a first hollow reinforcing structure and a second hollow reinforcing structure that are disposed one above the other and spaced apart from each other, and the first hollow reinforcing structure and the second hollow reinforcing structure are each filled with the anti-vibration material.

In one embodiment of the present disclosure, the anti-vibration material includes sand particles.

In one embodiment of the present disclosure, the iron core includes a plurality of limb portions, and the coil structure includes a plurality of core windings that are respectively wound onto the limb portions.

In one embodiment of the present disclosure, the electromagnetic assembly further includes a plurality of fastening members that are configured to join together the iron core and the coil structure.

In one embodiment of the present disclosure, an electrical insulating oil is present in the accommodating space of the transformer housing, and the electromagnetic assembly is immersed in the electrical insulating oil.

In one embodiment of the present disclosure, the power transformer having the noise reduction function further includes an oil storage tank that is in fluid communication with the accommodating space of the transformer housing via a pipe.

One of the beneficial effects of the power transformer having a noise reduction function provided by the present disclosure is that, by virtue of the transformer housing including a sidewall and an accommodating space surrounded by the sidewall, the sidewall having a vacuum layer formed therein, and the electromagnetic assembly disposed in the accommodating space of the transformer housing, transformer noises can be effectively reduced and blocked from being transmitted to the outside.

More specifically, the transformer housing can include at least one hollow reinforcing structure disposed on an outer wall of the sidewall and filled with an anti-vibration material. Therefore, the anti-vibration material is able to absorb or consume a vibration energy generated by a transformer body during normal operation of the power transformer, so as to allow for a significant noise reduction effect. In practice, the anti-vibration material can include sand particles, and a thermal energy generated by the friction and collision between the sand particles can be used to dissipate part of the vibration energy. Furthermore, the anti-vibration material can prevent an increase in noise due to the resonance between frequencies of structural vibrations and a power system.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a structural schematic view of a power transformer having a noise reduction function according to a first embodiment of the present disclosure;

FIG. 2 is a schematic enlarged view of part II of FIG. 1; and

FIG. 3 is a structural schematic view of a power transformer having a noise reduction function according to a second embodiment of the present disclosure.

### DETAILED DESCRIPTION OF THE EXEMPLARY EMBODIMENTS

Transformers are very important power equipment in any power transmission and distribution system. During the operation of a transformer, components such as a housing, a fan, an iron core and windings thereof generate noise, and part of the noise can be amplified due to a resonance effect, which could seriously disturb operating personnel (e.g., a technical staff or a maintenance staff). Therefore, the present disclosure provides a novel power transformer that is effective in reducing noise.

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

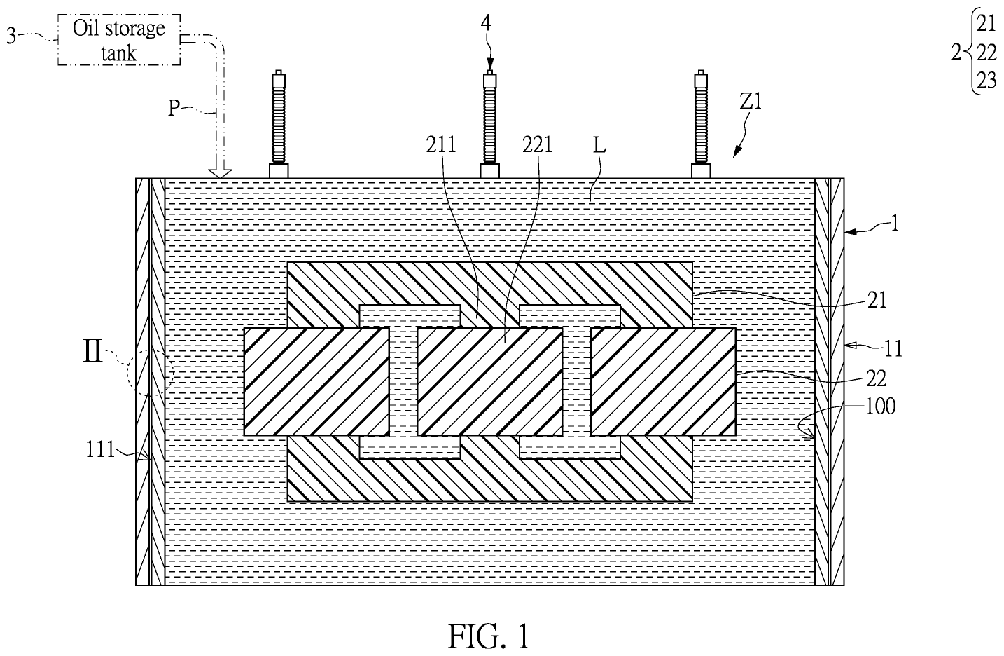

Referring to FIG. 1, a main structure of a power transformer Z1 having a noise reduction function according to a first embodiment of the present disclosure is shown. As shown in FIG. 1, the power transformer Z1 having the noise reduction function mainly includes a transformer housing 1 and an electromagnetic assembly 2. The transformer housing 1 includes a sidewall 11 and an accommodating space 100 surrounded by the sidewall 11. The electromagnetic assembly 2 is disposed in the accommodating space 100 of the transformer housing 1, and includes an iron core 21 and a coil structure 22 disposed on the iron core 21. In the present embodiment, the sidewall 11 of the transformer housing 1 has a vacuum layer 111 formed therein that functions as an acoustic enclosure and is effective at blocking transformer noises. Accordingly, the transformer noises can be contained within a limited space, so that noise radiation to the surrounding environment can be reduced.

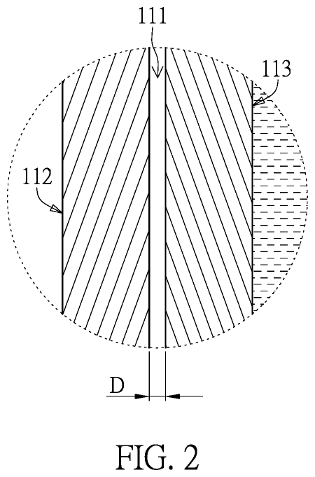

Referring to FIG. 2, which is to be read in conjunction with FIG. 1, the transformer housing 1 can be a cast-iron casting or a steel plate weldment, and at least one heat sink or fan (not shown in FIG. 1) can be mounted on the transformer housing 1 depending on particular requirements. The sidewall 11 of the transformer housing 1 includes an inner wall 113 and an outer wall 112, and the vacuum layer 111 is formed between the inner wall 113 and the outer wall 112 by sealing and evacuation. In order to block noise transmission and meet the requirements of particular applications such as increasing the strength of the sidewall 11 and reducing the wave amplitudes of the sidewall 11, a thickness D of the vacuum layer 111 is from 150 mm to 200 mm, which is from 90% to 92.5% of a total thickness of the sidewall 11. In certain embodiments, the thickness D of the vacuum layer 111 can be 150 mm, 160 mm, 165 mm, 170 mm, 175 mm, 180 mm, 185 mm, 190 mm, 195 mm, or 200 mm.

In the present disclosure, an electrical insulating oil L is present in the accommodating space 100 of the transformer housing 1, and the electromagnetic assembly 2 is immersed in the electrical insulating oil L. Specific examples of the electrical insulating oil L include vegetable oils, mineral oils, and synthetic oils. The electrical insulating oil L can not only provide internal insulation required for a transformer but also cool the iron core 21 and the coil structure 22. In practice, the power transformer Z1 having the noise reduction function can further include an oil storage tank 3 that is disposed above the transformer housing 1 and in fluid communication with the accommodating space 100 of the transformer housing 1 via a pipe P.

Furthermore, the iron core 21 can include a plurality of limb portions 211, and the coil structure 22 can include a plurality of core windings 221 that are respectively wound onto the limb portions 211. In practice, electrical insulation can be formed between the core windings 221, between the core windings 221 and the iron core 21, or between the core windings 221 and the transformer housing 1 by, for example, arranging one or more insulating papers therebetween. In addition, the electromagnetic assembly 2 can further include a plurality of fastening members 23 (e.g., metal clamps) that are configured to clamp together the iron core 21 and the coil structure 22 to form an assembly. For example, the iron core 21 and the coil structure 22 are sandwiched between the fastening members 23, and then the fastening members 23 are fixedly connected to each other by studs or the like. However, the above description is for exemplary purposes only and is not intended to limit the scope of the present disclosure.

More specifically, the iron core 21 can be an amorphous iron core made of amorphous alloy or silicon steel sheets. Each of the core windings 221 can include primary and secondary windings that can be formed by winding a number of copper wires. According to the number of phases and different coil configurations, the number of the limb portions 211 of the iron core 21 can be two, three, four, or five. The number of the core windings 221 can be equal to or less than that of the limb portions 211 of the iron core 21. Lead wires of the core windings 221 can extend to the outside of the transformer housing 1 and be connected to other devices through a number of bushings 4 for power transmission.

### Second Embodiment

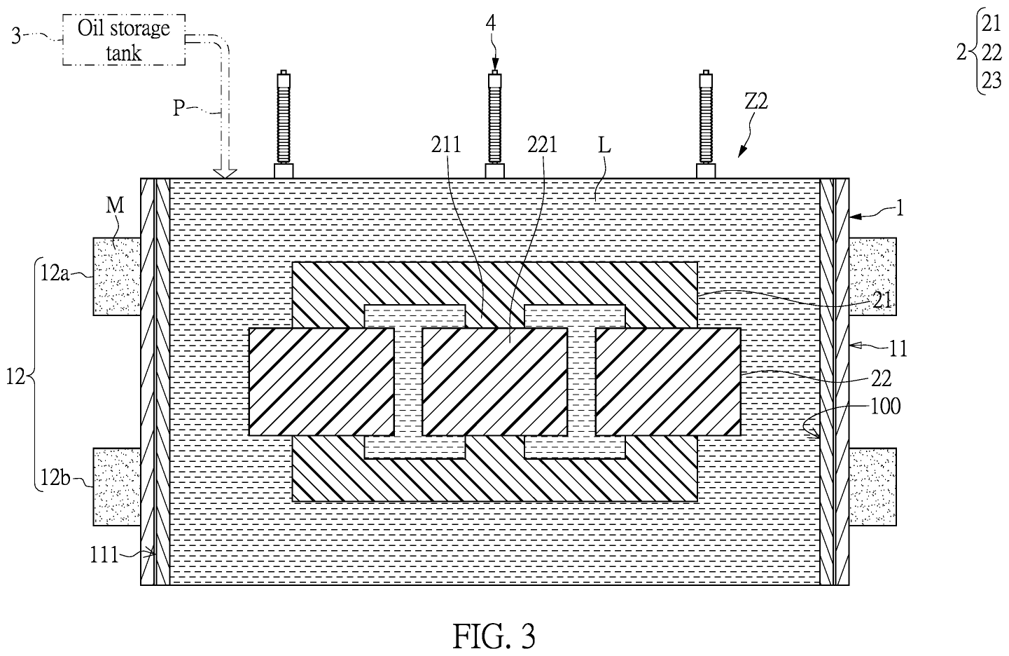

Referring to FIG. 3, a main structure of a power transformer Z2 having a noise reduction function according to a second embodiment of the present disclosure is shown. As shown in FIG. 3, the power transformer Z2 having the noise reduction function mainly includes a transformer housing 1 and an electromagnetic assembly 2. The transformer housing 1 includes a sidewall 11, an accommodating space 100 surrounded by the sidewall 11, and at least one hollow reinforcing structure 12 disposed on an outer wall of the sidewall 11. The electromagnetic assembly 2 is disposed in the accommodating space 100 of the transformer housing 1, and includes an iron core 21 and a coil structure 22 disposed on the iron core 21.

In the present embodiment, the sidewall 11 of the transformer housing 1 has a vacuum layer 111 formed therein that functions as an acoustic enclosure and is effective at blocking transformer noises. Accordingly, the transformer noises can be contained within a limited space, so that noise radiation to the surrounding environment can be reduced. In addition, the at least one hollow reinforcing structure 12 is filled with an anti-vibration material M, which is able to absorb or consume a vibration energy generated by a transformer body (e.g., the iron core 21 or coil structure 22) during the normal operation of the power transformer Z2, so as to allow for a significant noise reduction effect. It should be noted that the anti-vibration material M can avoid an increase in noise due to the resonance between a frequency of structural vibrations and a frequency of a power system (e.g., 50 Hz or 60 Hz).

In practice, the at least one hollow reinforcing structure 12 can surround the sidewall 11 of the transformer housing 1 and be arranged in a continuous or spaced manner. For example, the at least one hollow reinforcing structure 12 can include a first hollow reinforcing structure 12a and a second hollow reinforcing structure 12b that are disposed one above the other and spaced apart from each other, and the first hollow reinforcing structure 12a and the second hollow reinforcing structure 12b are each filled with the anti-vibration material M. Furthermore, the anti-vibration material M can include sand particles, and a thermal energy generated by the friction and collision between the sand particles can be used to dissipate part of the vibration energy. However, the above description is for exemplary purposes only and is not intended to limit the scope of the present disclosure.

It should be noted that although the anti-vibration material M including the sand particles is taken as an example to describe the features of the present disclosure, a damping material such as a rubber can also be used as the anti-vibration material M.

Since the relevant technical details mentioned in the first embodiment are also application in the present embodiment, they will not be repeated here for the sake of brevity. Similarly, the technical details mentioned in the present embodiment can also be applied in the first embodiment.

### Beneficial Effects of the Embodiments

One of the beneficial effects of the power transformer having a noise reduction function provided by the present disclosure is that, by virtue of the transformer housing including a sidewall and an accommodating space surrounded by the sidewall, the sidewall having a vacuum layer formed therein, and the electromagnetic assembly disposed in the accommodating space of the transformer housing, transformer noises can be effectively reduced and blocked from being transmitted to the outside.

More specifically, the transformer housing can include at least one hollow reinforcing structure disposed on an outer wall of the sidewall and filled with an anti-vibration material. Therefore, the anti-vibration material is able to absorb or consume a vibration energy generated by a transformer body during the normal operation of the power transformer, so as to allow for a significant noise reduction effect. In practice, the anti-vibration material can include sand particles, and a thermal energy generated by the friction and collision between the sand particles can be used to dissipate part of the vibration energy. Furthermore, the anti-vibration material can avoid an increase in noise due to the resonance between frequencies of structural vibrations and a power system.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A power transformer having a noise reduction function, comprising:
a transformer housing including a sidewall and an accommodating space surrounded by the sidewall, wherein the sidewall has a vacuum layer formed therein; and
an electromagnetic assembly disposed in the accommodating space and including an iron core and a coil structure disposed on the iron core.

2. The power transformer according to claim 1, wherein a thickness of the vacuum layer is from 90% to 92.5% of a total thickness of the sidewall.

3. The power transformer according to claim 1, wherein the transformer housing further includes at least one hollow reinforcing structure disposed on an outer wall of the sidewall, and the at least one hollow reinforcing structure is filled with an anti-vibration material.

4. The power transformer according to claim 3, wherein the anti-vibration material includes sand particles.

5. The power transformer according to claim 3, wherein the at least one hollow reinforcing structure surrounds the sidewall of the transformer housing.

6. The power transformer according to claim 3, wherein the at least one hollow reinforcing structure includes a first hollow reinforcing structure and a second hollow reinforcing structure that are disposed one above the other and spaced apart from each other, and the first hollow reinforcing structure and the second hollow reinforcing structure are each filled with the anti-vibration material.

7. The power transformer according to claim 1, wherein the iron core includes a plurality of limb portions, and the coil structure includes a plurality of core windings that are respectively wound onto the limb portions.

8. The power transformer according to claim 1, wherein the electromagnetic assembly further includes a plurality of fastening members that are configured to join together the iron core and the coil structure.

9. The power transformer according to claim 1, wherein an electrical insulating oil is present in the accommodating space of the transformer housing, and the electromagnetic assembly is immersed in the electrical insulating oil.

10. The power transformer according to claim 1, further comprising an oil storage tank that is in fluid communication with the accommodating space of the transformer housing via a pipe.
